(19) United States
(12) Patent Application Publication
(10) Pub. No.: US 2007/0171435 A1
(43) Pub. Date: Jul. 26, 2007

(54) Optimum usage of processing solution in printing

(75) Inventors: Leslie R. Wells, Bounds Green (GB); John R. Fyson, Hackney (GB)

Correspondence Address: Patent Legal Staff, Eastman Kodak Company, Rochester, NY, 14650-2201, US

(73) Assignee: EASTMAN KODAK COMPANY, Rochester, NY (US)

(21) Appl. No.: 10/588,913

(22) PCT Filed: Mar. 29, 2005
(86) PCT No.: PCT/GB05/01223

§ 371 Date: Aug. 9, 2006

(30) Foreign Application Priority Data
Apr. 15, 2004 (GB) 0408349.9

(51) Int. Cl. G06F 3/12; G06F 15/00; G06K 1/00

(52) U.S. Cl. 358/1.1

(57) ABSTRACT

The digital density information of a print order is obtained and an optimum sequence of printing the images of the order is determined that reduces the average print density form one print to another.

### FIELD OF THE INVENTION

This invention relates to photographic processing, more particularly to processors which have a very small print volume compared to the size of material being printed.

### BACKGROUND OF THE INVENTION

To prevent the working characteristics of a bath of photographic developer from changing during development of a quantity of exposed silver halide photographic material, and also to maintain the volume of the developer, it is common practice to add a replenisher. Such a replenisher is usually a more concentrated aqueous solution of principal developer constituents that are consumed during development. The replenisher has a reduced concentration of components released during development so that these compounds are diluted. In this way the developer tank solution can be maintained constant in composition.

The amount of replenisher required to keep the activity of the processing bath constant is dependent on the amount of chemical used or produced during processing. For example, dark prints (e.g. fireworks) use more developing agent in the developer to form a dense image compared to a light image (e.g. snow or beach scenes). If the negative is scanned, either to create a digital file for subsequent digital printing, or to measure its density, the density information can be used to adjust the replenishment rate using an appropriate algorithm. An example of such a method of controlling rate of replenishment is disclosed in U.S. Pat. No. 5,518,845.

### PROBLEM TO BE SOLVED BY THE INVENTION

Replenishment is usually carried out by pumping liquid into the processor. A change in replenishment rate can be achieved by changing the pump rate or by changing the period that a constant flow rate pump pumps for. If, for example, a processor contains 10 ml of liquid and is replenished at 100 ml/m² one tank turnover volume of liquid takes place for every 0.1 m² material processed. This corresponds to about 6 100×150 cm prints. If in one order the print density varies greatly from one end to another, for instance, the replenishment rate would have to vary greatly. This would mean either having a continuous pump designed to pump over a large range of rate, perhaps from 30-400 ml/m², or changing the time between pulses in a pulsed pump with a ratio of about 1:13. This is difficult to achieve with a variable speed pump and if the space between pumps with a pulsed pump is varied the tank concentration of chemical will oscillate with the same frequency. This would give rise to an undesirable variation in density along a print.

The invention aims to reduce the rate of change of replenishment rate required during an order when processed in a very small volume replenished processor. This in turn reduces the likelihood of replenishment errors during the processing of a print and also reduces the cost of pumps and pump control equipment. If the replenishment rate is changed during a print there will be a change along the print. This amount is dependent on the magnitude of change. By reducing the size of the change the variability along the print will be reduced in proportion.

### SUMMARY OF THE INVENTION

In very low volume systems or single use systems the seasoning of the chemistry and chemical usage can be affected by the Dmin/Dmax ratio within an order and also the distribution of different density prints within an order. The present invention relates to the organisation of prints within an order so that variation in seasoning effects and replenishment is minimised and within the order the variation in chemical usage from print to print is optimised. In digitally exposed systems it is possible to obtain the average density of each print within an order and then re-shuffle the order to a sequence which would achieve the maximum advantage for the chemical processing stage.

According to the present invention there is provided a method of printing an image onto photographic material comprising obtaining digital density information of a print order comprising a number of images, determining an optimum sequence of printing the images in the order, and printing the images in the optimum sequence.

### ADVANTAGEOUS EFFECT OF THE INVENTION

The present invention helps maintain the chemical stability of very low volume systems and single use systems. This in turn maintains consistency of density of prints or sensitometry. It is possible that the amount of processing solution can be optimised.

### BRIEF DESCRIPTION OF THE DRAWINGS

The invention will now be described with reference to the accompanying drawings in which:

FIG. 1 is a graph illustrating the variation in density found in example 1;

FIG. 2 is a graph illustrating the variation in density found in example 2; and

FIG. 3 is a graph illustrating the variation in density found in example 3.

### DETAILED DESCRIPTION OF THE INVENTION

A number of different density print scenarios were modelled with and without reordering and the average print density over a pair of prints estimated. If the replenishment rate is directly proportional to the density this average value could be used to control replenishment.

### EXAMPLE 1

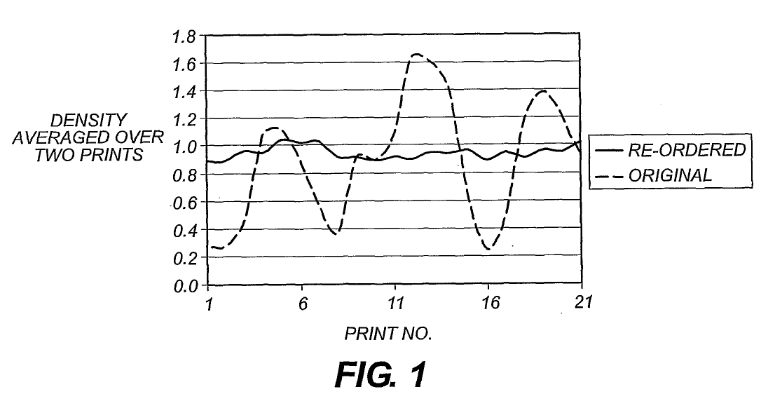

Using Excel™, a set of prints with random densities between 0 and 1.8 was simulated. The prints were sorted into density order and then re-ordered such that the densest was printed adjacent to the least dense, then the next densest next to the next least dense etc. The average running density of the pair were calculated. FIG. 1 compares the density averaged over two prints for both the original sequence and the re-ordered sequence. From FIG. 1 it can be seen that the variation in density was greatly reduced by re-ordering the pairs having the density distribution described above.

### EXAMPLE 2

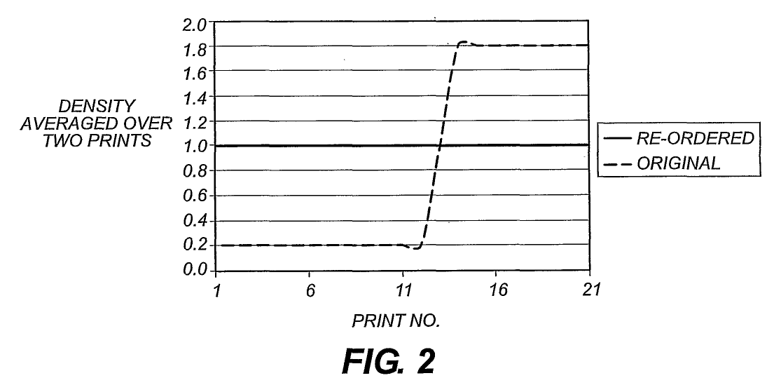

Using Excel™, a set of prints with low densities at the beginning of the order and high densities at the end of the order was simulated. The prints were sorted such that the densest was printed adjacent to the least dense, then the next densest next to the next least dense etc. The average running density of the pair was calculated. FIG. 2 compares the density averaged over two prints for both the original sequence and the re-ordered sequence. From FIG. 2 it can be seen that the variation in density was greatly reduced by re-ordering the pairs having the extreme density distribution described above.

### EXAMPLE 3

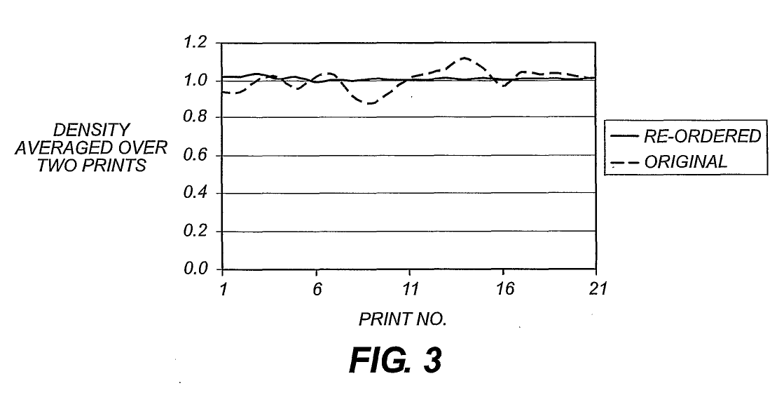

Using Excel™, a set of prints with a normal distribution of densities about a mean of one was simulated. The prints were sorted into density order and then re-ordered such that the densest was printed adjacent to the least dense, then the next densest next to the next least dense etc. The average running density of the pair was calculated. FIG. 3 compares the density averaged over two prints for both the original sequence and the re-ordered sequence. From FIG. 3 it can be seen that the variation in density is greatly reduced by re-ordering the pairs having the more realistic density distribution described above

The above examples illustrate that the variation in seasoning effects and replenishment is minimised if the prints are re-organised within an order. The chemical variation is thus minimised.

The invention has been described in detail with reference to preferred embodiments thereof. It will be understood by those skilled in the art that variations and modifications can be effected within the scope of the invention.

1. A method of printing an image onto photographic material comprising obtaining digital density information of a print order comprising a number of images, determining an optimum sequence of printing the images in the order, and printing the images in the optimum sequence.

2. A method as claimed in claim 1 wherein the images are printed in the sequence of the image having the highest density followed by the image having the least density, followed by the image having the next highest density, followed by the image having the next least density, the sequence being followed until all images are printed.

3. A method as claimed in claim 1 wherein the volume of solution used for printing in each process step is less than 100 ml.

4. A method as claimed in claim 3 wherein the volume of solution is less than 30 ml.

5. A method of controlling replenishment rate by printing an order of images as claimed in claim 1, whereby the variation in average print density is reduced from one print to another.

6. An apparatus for printing images onto photographic media comprising means for obtaining digital density of a print order comprising a number of images, means for determining an optimum sequence of printing the images in the order and means for printing the images in the optimum order.
